(19) United States
(12) Patent Application Publication
(10) Pub. No.: US 2004/0244357 A1
(43) Pub. Date: Dec. 9, 2004

(54) Divergent chevron nozzle and method

(76) Inventor: Mark L. Sloan, Newcastle, WA (US)

Correspondence Address: HARNESS, DICKEY & PIERCE, P.L.C., P.O. BOX 828, BLOOMFIELD HILLS, MI, 48303, US

(21) Appl. No.: 10/454,888

(22) Filed: Jun. 5, 2003

(51) Int. Cl. F02K 1/38

(52) U.S. Cl. 60/204; 60/262

(57) ABSTRACT

A convergent/divergent chevron flow nozzle for use with a jet engine. The flow nozzle includes a converging portion that terminates at a throat portion. Extending from the throat portion is a plurality of chevrons spaced apart by ventilation areas. The chevrons diverge from the nozzle exit flow direction of the flow nozzle. The diverging chevrons serve to increase the thrust produced by a jet engine associated with the flow nozzle during and reduce shock related noise at cruise conditions. The ventilation areas prevent over-expansion of the nozzle flow at takeoff and resulting shock related noise from the plume, and increases plume mixing to reduce jet exhaust noise during takeoff without negatively affecting the thrust generated by the exhaust flow. The flow nozzle can be implemented at both the fan nozzle and exhaust nozzle areas of a dual flow jet engine.

### FIELD OF THE INVENTION

The present invention relates to jet engines, and more particularly to a nozzle for use with a jet engine that not only reduces jet exhaust noise, but also increases the thrust produced by the jet engine.

### BACKGROUND OF THE INVENTION

For future aircraft presently under development, the amount of fuel burned during a cruise condition is anticipated to be an extremely important cost consideration. In addition, the amount of community noise generated during takeoff of such aircraft must be controlled in accordance with increasingly strict regulations governing the operation of commercial aircraft at airports. Similarly, in flight cabin noise from the engine exhaust flow can be significant at cruise and must be controlled for passenger comfort.

FIG. 1A shows a highly simplified, conventional convergent/divergent nozzle for a jet engine that includes a converging portion A and a diverging lip B. Another known nozzle configuration is shown in FIG. 1B which illustrates a converging nozzle C. These two established nozzle designs have proven effective for their intended purposes over somewhat limited ranges of operation. Specifically, the convergent nozzle is more effective operated at lower ratios of nozzle pressure to ambient pressure, (where the exhaust flow is subsonic), and the convergent/divergent nozzle is more effective operated at higher ratios of nozzle to ambient pressure, (where the exhaust flow is supersonic) However, over a single flight, transport jet aircraft engines will typically operate over a range of pressures ratios where the choice of either a conventional convergent/divergent design or a convergent design will compromise thrust, fuel flow, or jet noise at either takeoff, cruise, or both. In particular, When optimized to reduce fuel flow and plume noise due to shocks at high cruise pressure ratios, the conventional convergent/divergent nozzle over expands the flow at the lower takeoff pressure ratios. This results in penalties at takeoff both in thrust loss and higher jet noise from shocks created by the supersonic, over-expanded flow. To avoid this over-expansion problem at takeoff, a compromise nozzle close to the conventional convergent nozzle design has been usually chosen for conventional subsonic aircraft and the penalties in cruise fuel burn and cabin noise accepted. There still exists a need for an exhaust nozzle design which is more fully effective at both takeoff and cruise to produce overall lower fuel burn and lower jet engine noise than existing nozzle types.

Chevron nozzles with convergent chevrons, (convergent relative to the nozzle exit flow direction and shown in FIG. 1C), are also known and resemble the present invention in general appearance. However, compared to the present invention, the nozzle shown in FIG. 1C does not have a significant reduced fuel burn at cruise advantage since it does not have expansion surfaces downstream of the throat specifically designed to increase engine thrust. The convergent chevron nozzle also produces stronger shocks downstream in the plume and is therefore generally not as effective in reducing jet plume noise at cruise (and thus cabin noise at cruise). FIG. 1D illustrating a typical prior art dual flow jet engine nozzle without convergent chevrons, arrows “F” indicating flow through the nozzle “N”. FIG. 1E illustrates a prior art nozzle incorporating convergent chevrons “G”:

### SUMMARY OF THE INVENTION

The present invention is directed to an apparatus and method for a convergent/divergent chevron nozzle for use with a jet engine of an aircraft. The nozzle of the present invention effectively serves to reduce fuel burn and cabin noise of an aircraft during a cruise condition while also limiting the noise created by the jet exhaust during takeoff operation. The nozzle of the present invention is particularly well adapted for use with supersonic and near supersonic commercial aircraft, however, the invention is expected to find utility on a wide variety of commercial, military, and even private jet aircraft.

In one preferred embodiment, the nozzle of the present invention forms a mixed flow nozzle having a converging nozzle that converges to a throat portion. At the throat portion, a plurality of circumferentially spaced apart chevrons are formed which diverge from a nozzle exit flow direction, as defined by an axial centerline of the flow nozzle. The chevrons are separated by ventilation areas which begin downstream of the nozzle throat and extend to the end of the chevrons.

The nozzle of the present invention reduces cruise fuel burn and cabin noise from the plume similar to a conventional convergent/divergent nozzle optimized for cruise operation. But the present invention avoids the conventional convergent/divergent nozzle's limitations with over expansion of the flow at takeoff pressure ratios. Particularly, the present invention eliminates unstable over-expansion of the jet plume at takeoff by providing ventilation areas between the chevrons. Ambient air entrained at takeoff through the ventilation areas prevents over-expansion of the flow downstream of the throat and the resulting supersonic flow with shocks that causes thrust losses and noise that would typically be generated by a conventional convergent/divergent nozzle,

A preferred embodiment of the present invention applied to a dual flow jet engine is also disclosed. This embodiment applies the same principles to improve performance (reduce fuel burn) and reduce shock noise, relative to previous nozzle designs, as for the above described mixed flow nozzle application.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a simplified side view of a portion of a prior art, convergent/divergent flow nozzle;

FIG. 1B is a simplified cross sectional side view of a prior art convergent flow nozzle; and

FIG. 1C is a simplified cross sectional view of a prior art convergent chevron nozzle that reduces community and cabin noise in a manner different from that of the present invention;

FIG. 1D is a cross section of a conventional dual flow jet engine nozzle as used on typical subsonic commercial transport;

FIG. 1E is a cross section of a prior art convergent chevron dual flow jet engine nozzle for commercial transport aircraft to reduce community and cabin noise;

FIG. 2 is a simplified cross sectional side view of a flow nozzle in accordance with a preferred embodiment of the present invention.

FIG. 3 is a simplified side view of the flow nozzle of FIG. 2 showing further the expanding jet exhaust plume at typical cruise conditions with supersonic flow downstream of the throat;

FIG. 4 is a rear elevational view of the exhaust nozzle of FIG. 3 showing entrainment of ambient air into the jet exhaust flow by means of the ventilation areas between the chevrons at typical takeoff pressure ratios with subsonic flow downstream of the throat; and

FIG. 5 is a cross section of the present invention applied to a dual flow nozzle typical of a subsonic commercial transport.

### DETAILED DESCRIPTION OF THE PREFERRED EMBODIMENTS

The following description of the preferred embodiment(s) is merely exemplary in nature and is in no way intended to limit the invention, its application, or uses.

Referring to FIG. 2, there is shown a flow nozzle 10 in accordance with a preferred embodiment of the present invention. The flow nozzle 10 is used to house a jet engine 12 and includes a tubular, converging portion 14 which terminates at a throat portion 16. An axial centerline of the flow nozzle 10 is denoted by “C_{L}”. The direction of flow of exhaust gasses at the throat are indicated by arrow 18. The flow nozzle 10 forms a portion of a nacelle that is typically supported from a wing or fuselage of the aircraft.

Downstream of the throat portion 16 are a plurality of circumferentially arranged chevrons 20. The chevrons 20 are further formed such that they diverge from the centerline C_{L} by a predetermined angle. In one preferred form, the predetermined angle, represented by arrows 22, is between approximately 1°-10°, and more preferably comprises an angle of about 3° relative to a nozzle flow direction, the nozzle exit flow directors being represented by axial centerline C_{L}. The chevrons 20 are further separated by ventilation areas 24. The chevrons 20 extend back to near the throat portion 16, as do the ventilation areas 24. The chevrons 20 may vary significantly in length, but in one preferred form extend from the throat portion 16 a length of preferably about 10%-20% of the nozzle diameter, and more preferably about 15% of nozzle diameter. For an exemplary jet engine nozzle having a nozzle throat portion 16 diameter of typically about 80 inches (203.2 cm), this would translate to an overall length of about 8-16 inches (20.32 cm-40.64 cm) for the chevrons 20, as indicated by arrow 23 in FIG. 2. The total number of chevrons 20 provided will also vary depending upon the overall diameter of the flow nozzle 10, but typically between approximately 10-20 chevrons 20 are incorporated on an exemplary jet engine nozzle. The ventilation areas 24 each have an approximate triangular shape that is preferably the same as the chevrons 20.

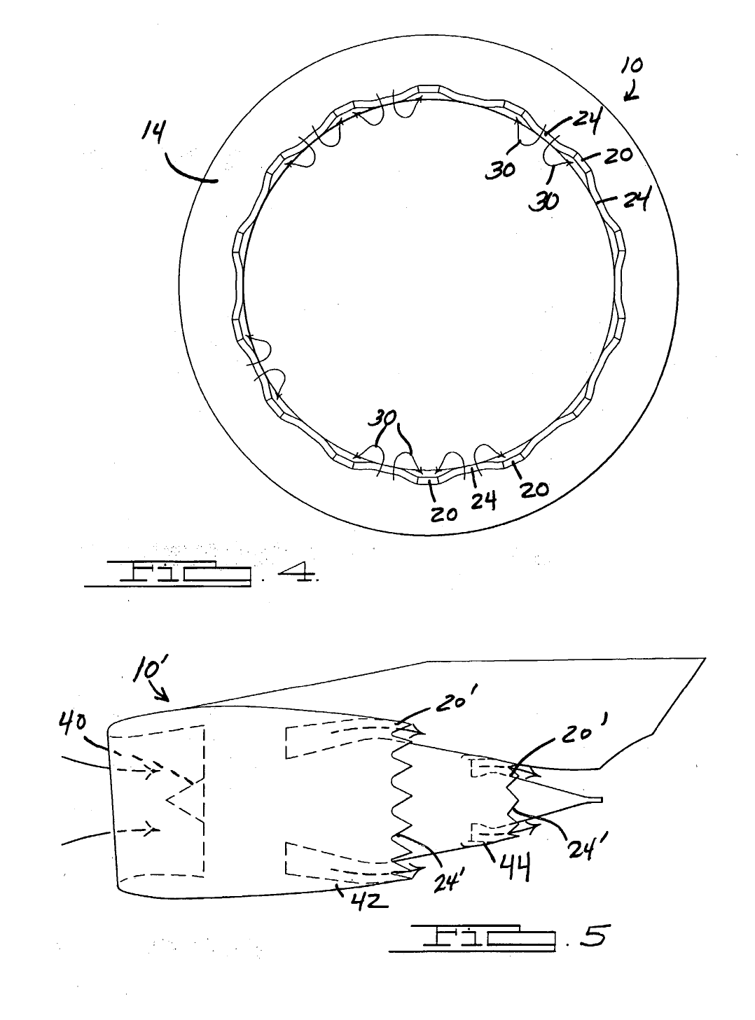

Referring to FIG. 3, a highly simplified illustration of the operation of the flow nozzle 10 is shown while the flow nozzle 10 is operating at a cruise condition while attached to an aircraft, the aircraft being represented in highly simplified form by structure 26, and the exhaust flow being denoted by reference numeral 28. During a cruise condition, the ratio of cruise nozzle flow 28 pressure to ambient pressure for a typical commercial transport aircraft will typically be about 3.0. At this condition, the exhaust flow 28 downstream of the throat portion 16 will be supersonic. As the exhaust flow 28 expands against the chevrons 20, the chevrons provide surfaces against which the expanding exhaust flow 28 plume can exert further force to effectively increase the thrust generated by the jet engine 12 in a manner similar to a conventional convergent/divergent nozzle. This increased thrust also provides the benefit of reducing fuel burn during cruise because of the increased thrust created. Moreover, due to the supersonic speed of the exhaust flow 28 through the throat portion 16, the ventilation areas 24 separating each chevron 20 do not significantly affect the generation of additional thrust on the surfaces of the chevrons 20. The presence of the divergent chevrons 20 also prevent sudden, unstable expansions of the jet plume, typical of a conventional convergent nozzle. Such sudden, unstable expansions of the jet plume can cause shocks downstream in the plume and shock noise that, under some conditions, may be audible within the cabin of the aircraft 26 during the cruise phase of flight, thus reducing passenger comfort.

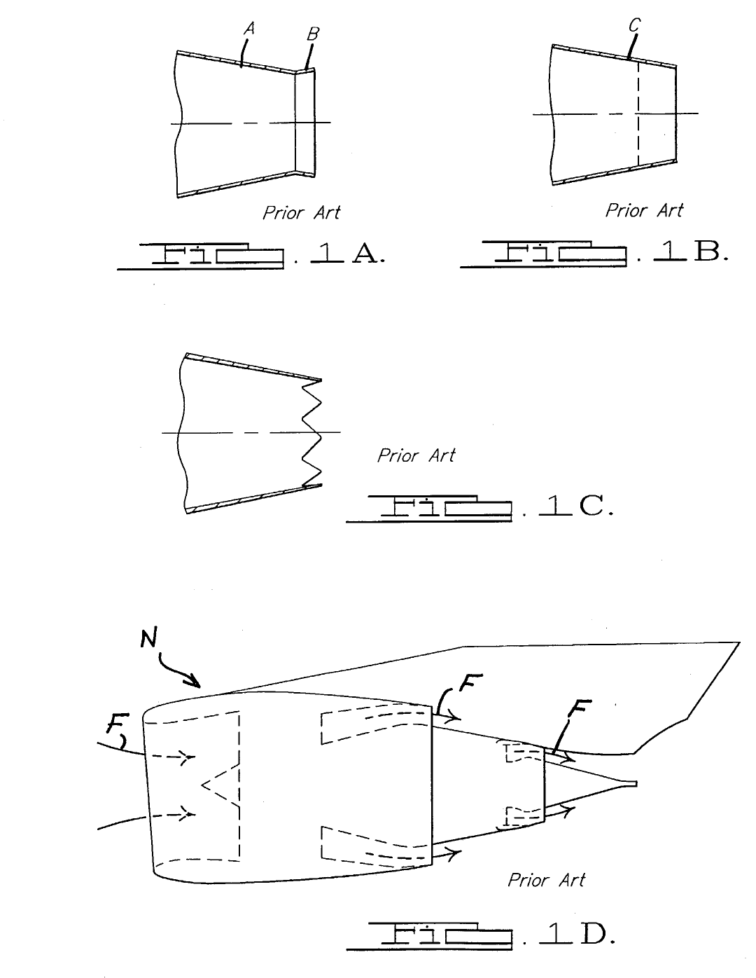

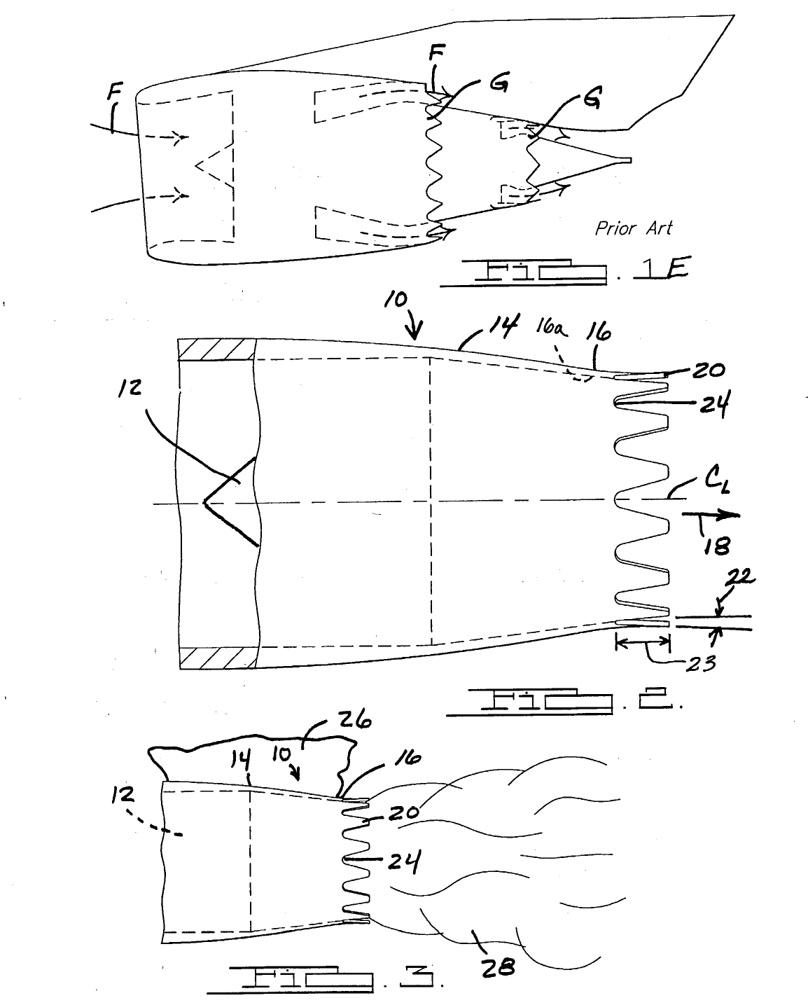

During a takeoff condition, it will be appreciated that a standard convergent nozzle, such as shown in FIG. 1B, typically will have a purely subsonic exhaust flow. At takeoff, the ratio of cruise nozzle exhaust flow 28 pressure to ambient pressure for a typical commercial transport aircraft is approximately 1.7, which will produce a subsonic flow downstream of the throat portion 16 for a conventional convergent nozzle. As illustrated in FIG. 4, the flow nozzle 10 of the present invention also produces a subsonic exhaust flow 28 by extending the ventilation areas 24 back to the throat portion 16 of the flow nozzle 10. The ventilation areas 24 allow ambient air to enter the nozzle downstream of the nozzle throat portion 16. Cold ambient air currents 30 are entrained in the hot exhaust flow 28 as the exhaust flow moves past the ventilation areas 24. This serves to prevent the exhaust flow 28 from being forced into a supersonic, over-expanded flow condition by the downstream expansion of the divergent chevrons 20. By avoiding over expansion and resulting shocks in the exhaust flow 28 plume at takeoff, the flow nozzle 10 of the present invention prevents thrust losses and excessive jet engine noise that would otherwise be generated with the conventional axisymmetric convergent/divergent nozzle, shown in FIG. 1A. The entrainment of ambient air and vortex formation illustrated in FIG. 4 also has the effect of increasing exhaust plume mixing rate, which has been shown to reduce plume noise relative to a conventional convergent nozzle at takeoff conditions.

It will also be appreciated that some small degree of surface contouring will also likely be preferred on the interior surface of the flow nozzle 10 at the throat portion 16. This would be helpful to further eliminate/reduce shocks that might be generated near the duct wall surface 16a by local curvature in the throat portion 16.

Referring now to FIG. 5, the flow nozzle 10′ of the present invention is shown incorporating chevrons 20′ and ventilation areas 24′ on a dual flow nozzle jet engine 40 at both a fan flow nozzle exit area 42 and a core flow nozzle exit area 44. It will be appreciated that the dual flow nozzle jet engine 40 is more typically employed with commercial jet transport aircraft, and the flow nozzle 10′ is expected to be particularly desirable for use with such aircraft in view of the increase in fuel economy and the reduction in community noise that the flow nozzle 10′ provides. The flow nozzle 10′, when incorporated with the dual flow nozzle jet engine 40, even further reduces fuel burn and community noise over that of the conventional dual flow nozzle configuration shown in FIG. 1E.

The flow nozzles 10 of the present invention thus provide a means for not only improving the thrust and reducing the noise created by a jet engine when operating at a cruise condition, but also to help limit jet exhaust losses and noise generated by a jet engine with a conventional convergent/divergent nozzle during a takeoff condition The flow nozzles 10 and 10′, while particularly well adapted for use with commercial aircraft, can just as readily be implemented on any form of aircraft that makes use of a jet engine where thrust and jet exhaust noise are important considerations that need to be taken into account. The flow nozzles 10 and 10′ of the present invention further can be implemented without the significant additional cost for additional, complex manufacturing procedures which could otherwise significantly impact the overall cost of forming the flow nozzle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A flow nozzle for use with a jet engine of an aircraft to reduce jet engine noise, comprising:
a circumferential wall for receiving a flow from said jet engine, said circumferential wall having an axial centerline extending therethrough;
said circumferential wall having a converging portion, a throat portion downstream of said converging portion relative to a direction of flow of said flow, and a plurality of chevrons extending from said throat portion downstream from said throat portion relative to said direction of said flow, said chevrons each further being formed to diverge away from said nozzle exit flow direction of said flow at a predetermined angle; and
said chevrons providing surfaces against which said flow is able to expand after said flow has passed said throat portion to avoid unstable expansion and resulting downstream shocks in a jet plume formed as said flow exits said throat portion.

2. The flow nozzle of claim 1, wherein said chevrons are separated by ventilation areas extending to said throat portion.

3. The flow nozzle of claim 2, wherein said ventilation areas each comprise a chevron-like shape.

4. The flow nozzle of claim 1, wherein said predetermined angle comprises an angle of between approximately 1-10 degrees.

5. The flow nozzle of claim 4, wherein said predetermined angle comprises an angle of approximately three degrees.

6. The flow nozzle of claim 1, wherein each said chevron has a length corresponding to approximately 10%-20% of a diameter of said throat portion of said flow nozzle.

7. A flow nozzle for use with a jet engine of an aircraft to reduce fuel burn when said aircraft is operating in a cruise condition, said flow nozzle comprising:
a circumferential wall for receiving an exhaust flow from said jet engine;
said circumferential wall having a converging portion, a throat portion downstream of said converging portion relative to a direction of flow of said exhaust flow, and a plurality of chevrons extending from said throat portion downstream from said throat portion relative to said direction of said exhaust flow, said chevrons each further being formed to diverge away from said a nozzle exit flow direction at a predetermined angle; and
said chevrons providing surfaces against which an expanding, supersonic exhaust flow impinges after passing said throat portion to increase a thrust generated from said flow nozzle.

8. The flow nozzle of claim 7, wherein said chevrons are each separated by ventilation areas extending back to said throat portion.

9. The flow nozzle of claim 8, wherein said ventilation areas each comprise a chevron-like shape.

10. The flow nozzle of claim 7, wherein said predetermined angle comprises an angle between about 1-10 degrees.

11. The flow nozzle of claim 10, wherein said predetermined angle comprises an angle of approximately three degrees.

12. The flow nozzle of claim 7, wherein each of said chevrons has a length corresponding to approximately 10%-20% of a diameter of said throat portion of said flow nozzle.

13. A flow nozzle for use with a jet engine of an aircraft, comprising:
a circumferential wall for receiving an exhaust flow from said jet engine;
said circumferential wall having a converging portion, a throat portion downstream of said converging portion relative to a direction of flow of said exhaust flow, and a plurality of chevrons extending from said throat portion downstream from said throat portion relative to said direction of said exhaust flow, said chevrons each further being formed to diverge away from a nozzle exit flow direction;
said chevrons providing surfaces against which said exhaust flow is able to expand after said exhaust flow has passed said throat portion to suppress sudden, unstable expansion of a jet plume exiting said throat portion; and
said chevrons being separated by ventilation areas extending to said throat portion.

14. The flow nozzle of claim 13, wherein said chevrons diverge away from said coaxial centerline at an angle of between approximately 1-10 degrees.

15. The flow nozzle of claim 14, wherein said chevrons diverge away from said nozzle exit flow direction at an angle of approximately three degrees.

16. The flow nozzle of claim 14, wherein said ventilation areas comprise chevron-like ventilation areas.

17. The flow nozzle of claim 13, wherein each one of said chevrons has a length corresponding to approximately 10%-20% of a diameter of a throat portion of said flow nozzle.

18. A method for increasing a thrust generated by a jet engine of an aircraft during a cruise operating condition of said aircraft, said method comprising:
using a circumferential nozzle adjacent said jet engine to direct a flow generated by said jet engine into a gradually converging flow stream as said flow reaches a throat portion of said nozzle; and
using a plurality of chevron-shaped projections arranged to extend circumferentially from said throat portion, and diverging from a nozzle exit flow direction, to receive said flow as said flow exits past said throat portion, to thereby provide surfaces against which said flow can impact and thereby generate additional thrust.

19. The method of claim 18, further comprising arranging said chevron-shaped projections to diverge at an angle of approximately 1-10 degrees from said nozzle exit flow direction of said circumferential nozzle.

20. The method of claim 19, further comprising arranging said chevron-shaped projections to diverge at angle of approximately three degrees from said nozzle exit flow direction.

21. The method of claim 18, further comprising separating adjacent ones of said chevron-shaped projections by ventilation areas that extend to said throat portion.

22. The method of claim 21, further comprising forming said ventilation areas as chevron-like ventilation areas.

23. The method of claim 18, further comprising using chevron-shaped projections that each have a length of approximately 10%-20% of a diameter of said throat portion of said nozzle.

24. A method for reducing fuel burn of a jet engine of an aircraft during a cruise operating condition of said aircraft, said method comprising:
directing a flow from said jet engine through a converging portion of a flow exit nozzle;
using a plurality of chevron-shaped projections on said flow exit nozzle arranged to extend circumferentially downstream from a throat portion of said exhaust nozzle, and in a diverging fashion from a nozzle exit flow direction, to receive said flow flowing past said throat portion, such that said flow impinges said chevron-shaped projections and generates additional thrust.
allowing a portion of said exhaust flow to escape through ventilation areas formed between adjacent ones of said chevron-shaped projections.

25. The method of claim 24, further comprising forming said chevron-shaped projections to diverge from said nozzle exit flow direction at an angle of approximately between 1-10 degrees.

26. The method of claim 25, further comprising forming said chevron-shaped projections to extend from said nozzle exit flow direction at an angle of approximately three degrees.

27. The method of claim 24, further comprising forming ventilation areas, each including a chevron-like shape, in between adjacent ones of said chevron-shaped projections.

28. The method of claim 24, further comprising using chevron-shaped projections that each have an overall length of approximately 10%-20% of a diameter of said throat portion of said nozzle.

29. A method for reducing jet engine noise produced by a flow exiting the jet engine, the method comprising:
directing the flow discharged by the jet engine through a converging portion of an exit nozzle;
causing said flow to impinge chevron-shaped areas projecting from said exit nozzle downstream of said converging portion, said chevron-shaped areas diverging from a nozzle exit flow direction of said flow and operating to provide surfaces against which a plume forming from said flow impinge, so as to suppress sudden, unstable expansion of said plume, and thus inhibit noise that would otherwise be generated by said sudden, unstable expansion of said plume.

30. A method for reducing at least one of fuel burn and noise generated by a jet engine, comprising:
directing a flow from a jet engine through a flow nozzle having a circumferential throat portion, wherein the throat portion has a diameter narrower than an upstream portion of said flow nozzle;
causing said flow to exit from said throat portion and to impinge a plurality of chevron-like projections projecting from said throat portion, and spaced apart radially around said exhaust nozzle downstream of said throat portion;
orientating said chevron-like projections in a diverging manner such that all of said chevron-like projections diverge away from an axial centerline of said flow nozzle; and
providing said chevron-like projections each with a length that is between approximately 10%-20% of a diameter of said throat portion.
